(19) United States
(12) Patent Application Publication
(10) Pub. No.: US 2006/0092658 A1
(43) Pub. Date: May 4, 2006

(54) Vehicle luminaire arrangement

(75) Inventor: Bernd-Heiner Scholz, Friedrichsdorf (DE)

Correspondence Address: OSRAM SYLVANIA INC, 100 ENDICOTT STREET, DANVERS, MA, 01923, US

(73) Assignee: PATENT-TREUHAND-GESSELLSCHAFT FUR ELEKTRISCHE GLUHLAMPEN MBH, MUNCHEN (DE)

(21) Appl. No.: 11/262,800

(22) Filed: Nov. 1, 2005

(30) Foreign Application Priority Data
Nov. 3, 2004 (DE) 10 2004 053 643.0

(51) Int. Cl. F21S 8/10

(52) U.S. Cl. 362/545; 362/540

(57) ABSTRACT

A vehicle luminaire arrangement having at least one light source and a light-transmissive cover that forms an emitting surface is disclosed, the luminaire arrangement being secured in a receptacle of the vehicle. According to the invention, the receptacle is an impression into which the luminaire arrangement is inserted and terminates flush with an external contour of the vehicle.

### TECHNICAL FIELD

The invention relates to a vehicle luminaire arrangement having at least one light source and a light-transmissive cover which forms an emitting surface, the luminaire arrangement being secured in a receptacle of the vehicle and to a luminaire for a vehicle luminaire arrangement.

### BACKGROUND ART

Luminaire arrangements of this type are used, for example, in the field of vehicle technology for rear lights, brake lights, indicator lights and the like. Lamp modules which have already been preassembled and are provided with an additional inner housing in order to protect the luminaire arrangement and the vehicle interior from environmental influences are often inserted into installation openings in the bodywork. Light-emitting diodes (LEDs) are being used to an increasing extent in such lamp modules instead of conventional incandescent lamps since said LEDs have a longer service life, better efficiency and a lower space requirement. Owing to the fact that an individual light-emitting diode has a lower luminance than a conventional incandescent lamp, a plurality of light-emitting diodes which are arranged on a printed circuit board are usually used as a light-emitting diode arrangement.

Such a vehicle luminaire having a light-emitting diode arrangement is disclosed, for example, in DE 103 04 832 A1. This vehicle luminaire uses a step-like holder that is matched to the contour of a light cap in order to accommodate the light-emitting diodes, the latter being arranged on an edge of the holder that is adjacent to the light cap and essentially following the contour of the light cap. The disadvantage of such vehicle luminaires is, on the one hand, that the rigidity of the bodywork is reduced in the region of the luminaires on account of the installation openings which are required and, on the other hand, that an additional inner housing and thus increased installation complexity are required in order to protect the lamp modules and the vehicle interior from environmental influences, in particular from contamination and the ingress of moisture.

### DISCLOSURE OF THE INVENTION

The invention is based on the object of providing a vehicle luminaire arrangement having a luminaire which has a simpler design than conventional solutions and enables improved rigidity of the bodywork.

This object is achieved, as regards the vehicle luminaire arrangement, by a vehicle luminaire arrangement having at least one light source and a light-transmissive cover which forms an emitting surface, the luminaire arrangement being secured in a receptacle of the vehicle, wherein the receptacle is an impression into which the luminaire arrangement is inserted and terminates flush with an external contour of the vehicle, and as regards the luminaire, by means of A luminaire for a vehicle luminaire arrangement having a flexible printed circuit board which is designed in such a manner that it can be flexibly adapted to a bottom surface of a receptacle in the vehicle bodywork. Particularly advantageous embodiments of the invention are described in the dependent claims.

The vehicle luminaire arrangement according to the invention has a light source and a light-transmissive cover (which forms an emitting surface) and is secured in a receptacle of the vehicle. According to the invention, the receptacle is in the form of an impression into which the luminaire is inserted and terminates flush with an external contour of the vehicle. In contrast to the prior art, there is no need for an installation opening (for accommodating the lighting system) with the associated reduced rigidity of the bodywork in this region. Furthermore, there is no need for an additional inner housing since the luminaire arrangement and the vehicle interior are terminated by the impression and are protected from environmental influences, in particular from contamination and the ingress of moisture. The impression can be made in the bodywork using forming processes, for example a pressing process, which are known from the general prior art.

The luminaire (in accordance with the coordinate claim 12) which can be used in the vehicle lamp arrangement according to the invention has a printed circuit board that can be elastically deformed in accordance with the curvature of a bottom surface of the impression. Arranging the light source on the elastic printed circuit board makes it possible to dispense with adaptation to the geometry of the bottom surface of the impression. In contrast to the prior art, this makes it possible to make design changes to the vehicle without changing the configuration of the luminaire and with reduced manufacturing complexity.

The light source used is preferably at least one light-emitting diode (LED) and is particularly advantageously a light-emitting diode arrangement that is arranged on a printed circuit board in the vehicle luminaire arrangement.

It has proved to be particularly advantageous to connect the printed circuit board to the bottom surface of the impression over its entire area, preferably to adhesively bond it to said bottom surface. Connecting the printed circuit board to the bottom surface makes it possible to reliably install the printed circuit board and allows a low overall height of the vehicle luminaire arrangement in the impression.

The printed circuit board preferably has a plug connector which can be used to electrically contact-connect said printed circuit board.

The plug connector preferably projects into an assembly recess in the impression and has at least one holding apparatus, in particular a latching tab, which is used to hold said plug connector in the assembly recess.

In one preferred embodiment of the invention, the light-transmissive cover is curved or can be elastically deformed in accordance with the external contour of the vehicle. By way of example, the cover may be adapted, as a result of its elastic configuration, to the external contour of the vehicle bodywork, that is to say the vehicle luminaire arrangement according to the invention can be used in similar vehicle types and models, the manufacturing complexity being reduced further. Shaping is simplified since there is no need for any highly complex 3D component with high tool costs, for example during injection molding, but rather use is made of relatively simple molds which thus reduce the tool costs.

The cover preferably has a light-directing optical structure. This structure has, for example, focusing or scattering optics with lens or prism systems and makes it possible to direct the light generated by the light source in the required manner depending on the application.

The light-directing optical structure advantageously has saw-tooth-like projections which are each assigned to a light-emitting diode and cover at least sections of the latter.

It has proved to be advantageous if the light-directing optical structure has at least one concave light entrance surface.

The cover is preferably connected to the impression by means of a connecting compound, in particular silicone.

### BRIEF DESCRIPTION OF THE DRAWINGS

The invention is explained in more detail below with reference to one preferred exemplary embodiment. In the drawing:

FIG. 1 shows a cross section of a vehicle luminaire arrangement according to the invention that is inserted into a vehicle.

### BEST MODE FOR CARRYING OUT THE INVENTION

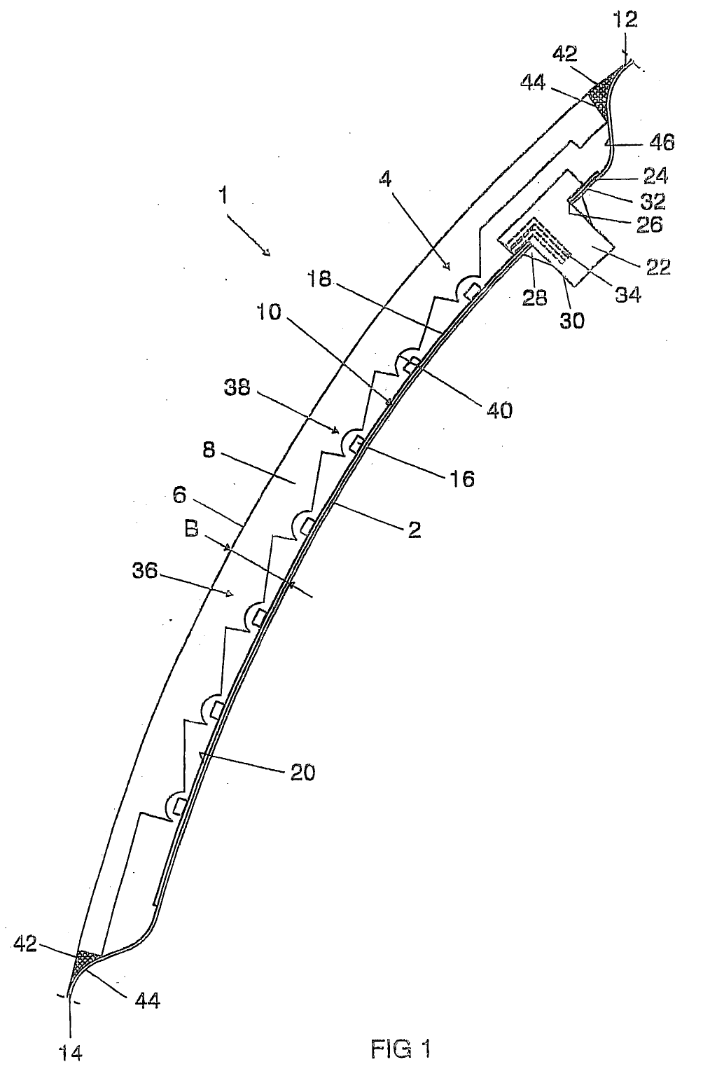

FIG. 1 shows a vehicle luminaire arrangement 1 having a light-emitting diode arrangement 4 that is arranged on a printed circuit board 2 and a light-transmissive cover 8 that forms an emitting surface 6.

According to the invention, the vehicle luminaire arrangement 1 is secured in an impression 10 in a vehicle bodywork 12 and terminates flush with an external contour 14 of the vehicle. The term impression 10 is preferably understood as meaning a depression in the vehicle bodywork 12, the longitudinal extent of which depression is a multiple of the value of the depth, in particular at least five times the depth. In contrast to the prior art, the impression 10 means that there is no need for an installation opening (for accommodating the lighting system) with the associated reduced rigidity of the bodywork 12 in this region. Since the luminaire arrangement 1 and the vehicle interior are terminated by the impression 10 and are protected from environmental influences, in particular from contamination and the ingress of moisture, it is possible to dispense with an additional inner housing and to considerably reduce the manufacturing complexity. The light-emitting diode arrangement 4 (LED array) used in the vehicle luminaire arrangement 1 is formed by one or more light-emitting diodes 16 which are arranged in the manner of a matrix on a surface 18 of the printed circuit board 2. Depending on the application and the desired lighting effect, different arrangements of the light-emitting diodes 16 are possible. By way of example, the latter may be arranged in one or more rows next to one another, over the entire area, or partially.

In contrast to the prior art, the printed circuit board 2 is not inflexible but elastic, the components secured on the printed circuit board 2 being arranged in such a manner that they allow this elasticity. The printed circuit board 2 is elastically deformed in accordance with the curvature of a bottom surface 20 of the impression 10 and is adhesively bonded to the latter over its entire area. At least sections of the bottom surface 20 of the impression 10 run, at a distance B, parallel to the emitting surface 6 and the external contour 14 of the vehicle bodywork 12. Adhesively bonding the printed circuit board 2 to the bottom surface 20 over its entire area means, on the one hand, that the printed circuit board 2 is reliably installed and the luminaire arrangement 1 has a low overall height in the impression 10 and, on the other hand, that the manufacturing complexity is considerably reduced since arranging the light-emitting diodes 16 on the elastic printed circuit board 2 makes it possible to dispense with detailed 3D adaptation to the geometry of the bottom surface 20 of the impression 10. In contrast to the prior art, design changes can be made to the vehicle bodywork 12 without changing the printed circuit board 2 and with considerably reduced manufacturing complexity since no inflexible carrier plates which are matched to the contour of the emitting surface are used.

The printed circuit board 2 of the vehicle luminaire arrangement 1 and thus the light-emitting diodes 16 installed on said printed circuit board are electrically contact-connected by means of a plug connector 22. The latter has an approximately T-shaped cross section and is brought into contact, via an annular surface 24, with the surface 18 of the printed circuit board 2, penetrates the latter and projects into an assembly recess 26 in the impression 10. In contrast to the large-area installation opening required in the prior art, only one relatively small assembly recess for accommodating the plug connector 22 is required according to the invention. The plug connector 22 is held in the assembly recess 26 by means of latching tabs 28 and additionally secures the printed circuit board 2 in the impression 10. To this end, the latching tabs 28 are arranged diametrically on a circumferential surface 30 of the plug connector 22 and have an approximately wedge-shaped cross section which, when the plug connector 22 is inserted, engages behind a wall 32 of the impression 10. For the purposes of electrical contact connection, the plug connector 22 is provided with contact pins 34 (indicated using dashed lines).

The light-transmissive cover 8 of the vehicle lamp arrangement 1 is curved in accordance with the external contour 14 of the vehicle bodywork 12 and terminates flush with the latter. The cover has a light-directing optical structure 36 having saw-tooth-like projections 38 which are each assigned to one of the light-emitting diodes 16 and cover sections of the latter with a concave light entrance surface 40, with the result that the cover 8 forms a type of plano-concave lens system in the region of each light-emitting diode 16. On the light-exit side, the cover 8 of the vehicle luminaire arrangement 1 has that emitting surface 6 which is matched to the external contour 14. The cover 8 is connected, on a circumferential end face 44, to a circumferential surface 46 of the impression 10 by means of a connecting compound (sealing compound) 42, for example silicone, and, as a result, is held in the impression 10. As a result of the connecting compound 42, the vehicle luminaire arrangement 1 is terminated tightly in such a manner that it is protected from environmental influences.

Installing the vehicle luminaire arrangement 1 in the vehicle bodywork essentially involves the following steps: in a first operation, the surface 18 of the printed circuit board 2 is populated with light-emitting diodes 16 in the form of a light-emitting diode arrangement 4 and is provided with a plug connector 22. This prefabricated unit is then inserted into the impression 10, elastically deformed in accordance with the curvature of the bottom surface 20 of the impression 10 and adhesively bonded to the latter over its entire area. In the following work step, the printed circuit board 2 is electrically contact-connected by means of the plug connector 22. Finally, the light-transmissive cover 8 is inserted into the impression 10 such that it is flush and is connected to a circumferential surface 46 of the impression 10 by means of a connecting compound 42.

The vehicle luminaire arrangement 1 according to the invention is not restricted to the light-emitting diode arrangement 4 described but rather any light source known from the prior art or a combination of different light sources may be used. By way of example, a combination of an incandescent lamp for illuminating the roadway and a light-emitting diode arrangement 4 for the indicator lights is possible in a motor vehicle headlight.

A vehicle luminaire arrangement 1 having at least one light source 16 and a light-transmissive cover 8 that forms an emitting surface 6 is disclosed, the luminaire arrangement 1 being secured in a receptacle of the vehicle. According to the invention, the receptacle is an impression 10 into which the luminaire arrangement 1 is inserted and terminates flush with an external contour 14 of the vehicle.

1. A vehicle luminaire arrangement having at least one light source and a light-transmissive cover which forms an emitting surface, the luminaire arrangement being secured in a receptacle of the vehicle, wherein the receptacle is an impression into which the luminaire arrangement is inserted and terminates flush with an external contour of the vehicle.

2. The vehicle luminaire arrangement as claimed in claim 1, the light source having at least one light-emitting diode (LED), preferably a light-emitting diode arrangement that is arranged on a printed circuit board.

3. The vehicle luminaire arrangement as claimed in claim 2, it being possible for the printed circuit board to be elastically deformed in accordance with the curvature of a bottom surface of the impression.

4. The vehicle luminaire arrangement as claimed in claim 3, the printed circuit board being connected to the bottom surface of the impression over its entire area, preferably being adhesively bonded to said bottom surface.

5. The vehicle luminaire arrangement as claimed in claim 2, the printed circuit board having a plug connector and being able to be electrically contact-connected by means of the latter.

6. The vehicle luminaire arrangement as claimed in claim 5, the plug connector projecting into an assembly recess of the impression and having at least one holding apparatus, in particular a latching tab, for being held in the assembly recess.

7. The vehicle luminaire arrangement as claimed in claim 1, the cover being curved or being able to be elastically deformed in accordance with the external contour.

8. The vehicle luminaire arrangement as claimed in claim 1, the cover having a light-directing optical structure).

9. The vehicle luminaire arrangement as claimed in claim 8, the light-directing optical structure having saw-tooth-like projections which are each assigned to a light-emitting diode (and cover at least sections of the latter.

10. The vehicle luminaire arrangement as claimed in claim 8, the light-directing optical structure having at least one concave light entrance surface.

11. The vehicle luminaire arrangement as claimed in claim 1, the cover being connected to the impression by means of a connecting compound, in particular silicone.

12. A luminaire for a vehicle luminaire arrangement, in particular as claimed in claim 1, having a flexible printed circuit board which is designed in such a manner that it can be flexibly adapted to a bottom surface of a receptacle in the vehicle bodywork.
